(19) United States
(12) Patent Application Publication
(10) Pub. No.: US 2018/0270109 A1
(43) Pub. Date: Sep. 20, 2018

(54) MANAGEMENT OF NETWORK DEVICE CONFIGURATION SETTINGS

(71) Applicant: Microsoft Technology Licensing, LLC, Redmond, WA (US)

(72) Inventor: William K. HOLLIS, Duvall, WA (US)

(73) Assignee: Microsoft Technology Licensing, LLC, Redmond, WA (US)

(21) Appl. No.: 15/459,635

(22) Filed: Mar. 15, 2017

(51) Int. Cl. H04L 12/24; H04L 29/08; H04L 12/26; H04L 29/06

(52) U.S. Cl. CPC H04L 41/0803; H04L 67/10; H04L 63/08; H04L 63/101; H04L 43/08

(57) ABSTRACT

A network configuration management system can determine configuration settings for network devices and detect configuration setting errors in the configuration settings that can cause security vulnerabilities. The configuration setting errors can include a configuration setting value error or a supplemental access setting error. If the configuration settings include the configuration setting value error, a first remedial action can be executed, and if the configuration settings include the supplemental access setting error, a second remedial action can be executed. Also, network interface scanning can be initiated using network addresses extracted from the configuration settings.

### BACKGROUND

Large scale networks may have hundreds or thousands of network devices. Typically, it is the job of network administrators to configure and manage these network devices. Operations for configuring and managing the network devices may be performed at various stages. For example, at installation, various settings of the network devices may be configured to facilitate use of the network devices for their particular networks or for their particular network segments, such as for a particular virtual local area network (VLAN) or local area network (LAN). Also, settings may be configured to comply with network security policies. For example, access control lists (ACLs) may be configured to control inbound and outbound traffic for the network. Also, once the network devices are installed and are operational, a network monitoring tool may be used to monitor network traffic routed through the network devices and to detect network problems. System administrators may manually re-configure settings on one or more network devices to correct network problems or to perform updates. Manual updates can lead to user errors in the settings, which can create security vulnerabilities in network devices and make the network devices more susceptible to network attacks. Furthermore, detection of vulnerabilities caused by user error can be difficult, and, as a result, the vulnerabilities may not become known until after an attack has occurred.

### SUMMARY

According to an embodiment of the present disclosure, a network configuration management system includes at least one processor and at least one data storage storing machine readable instructions executable by the at least one processor. The at least one processor may determine configuration settings for at least one network device; determine whether the configuration settings include a configuration setting error comprising a configuration setting value error or a supplemental access setting error; if the configuration settings include the configuration setting value error, execute a first remedial action; and if the configuration settings include the supplemental access setting error, execute a second remedial action.

According to another embodiment, machine readable instructions are stored on at least one non-transitory computer readable medium. The machine readable instructions are executable by at least one processor to determine configuration settings for network devices; determine whether the configuration settings include configuration setting errors comprising a simple network management protocol community string set to a default value, a log destination configuration setting set to an incorrect destination, and a configuration setting allowing a user to login as a root user; and when the configuration settings include at least one of the configuration setting errors, execute a remedial action.

According to yet another embodiment, a computer-implemented method comprises determining configuration settings for at least one network device; determine the configuration settings include a configuration setting error; determining whether the configuration setting error comprises an intentional configuration setting error or an unintentional configuration setting error; in response to determining the configuration setting error comprises the intentional configuration setting error, executing a first remedial action; and in response to determining the configuration setting error comprises the unintentional configuration setting error, executing a second remedial action.

### BRIEF DESCRIPTION OF DRAWINGS

Embodiments and examples are described in detail in the following description with reference to the following figures. The embodiments are illustrated by examples shown in the accompanying figures in which like reference numerals indicate similar elements.

FIG. 1 illustrates a network configuration management system, according to an embodiment;

FIG. 2 illustrates managing configuration settings of a network device, according to an embodiment;

FIG. 3 illustrates a method for detecting configuration setting errors, according to an embodiment;

FIG. 4 illustrates a method for scanning network interfaces, according to an embodiment; and

FIG. 5 illustrates a computer platform for the network configuration management system, according to an embodiment.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

According to embodiments of the present disclosure, a network configuration management system may determine configuration settings for network devices in a network and detect configuration setting errors in the network devices. Also, the network configuration management system may determine network addresses for interfaces of the network devices, and initiate scanning of the network interfaces to detect network interface errors that may be related to access control list (ACL) failures, open ports, etc. The configuration management system may execute automated remedial actions to correct configuration setting errors and security vulnerabilities detected through the scanning of the network interfaces.

According to an embodiment, network devices may include physical devices of a network infrastructure. Examples of network devices may include routers, e.g., layer 3 switches (layer refers to a layer in the Open Systems Interconnection (OSI) model), network hubs, layer 2 switches, firewalls, load balancers, gateways, bridges, etc.

A configuration setting of a network device may include a parameter of the network device that can be adjusted or set, and the parameter is used to control an operation of the network device. Examples of configuration settings for a router may include interface settings that include the Internet Protocol (IP) address, type of interface (e.g., Ethernet, Asynchronous Transfer Mode (ATM), Fast Ethernet, loopback, etc.), transmission speed, encapsulation type, etc. Other types of configuration settings may include encryption/decryption settings, event logging (e.g., syslog), ACLs which may specify rules for forwarding network traffic, credentials (e.g., login identifier (ID) and/or password, SNMP connection strings) for authenticating users to allow access to configuration settings of the network device, etc. Different types of network devices may have different configuration settings.

Examples of configuration setting errors that may be detected by the network configuration management system may include configuration settings that are set to incorrect values and configuration settings that may be extra data that should not be stored in the network device, such as unapproved administrator credentials that can allow unapproved users to login to a network device. Examples of these types of configuration setting errors are further discussed below. Also, configuration setting errors may be detected by comparing configuration settings of a network device to configuration settings that are predetermined to be correct. In an embodiment, configuration files may be retrieved from network devices in the network, and the configuration files include the configuration settings of the network devices. A configuration file of a network device may be parsed to identify information about the network device and the configuration settings of the network device. The information about the network device, such as type, brand, model, operating system, etc., may be used to identify a predetermined set of correct configuration settings for that particular network device for a comparison, and to identify differences that may be configuration setting errors.

The network configuration management system may execute automated remediation operations to correct detected configuration setting errors. For example, the network configuration management system may access a network device in the network to modify a configure setting to a correct value. In an embodiment, the network configuration management system may estimate whether a detected configuration setting error is intentional error or unintentional errors and may remediate the error differently depending on whether the configuration setting error is determined to be intentional or unintentional. An intentional error may be indicative of a malicious attempt to gain unauthorized access to the network device or other resources in the network. An unintentional error may be caused by user errors.

As indicated above, the network configuration management system may initiate scanning of network interfaces, such as ports, of network devices. For example, IP addresses of network interfaces may be retrieved with other configuration settings of the network devices. The IP addresses may be used to conduct the scan of the network interfaces of the network devices to ensure the network interfaces are correctly configured and to test whether the network interfaces are forwarding and blocking traffic according to their ACLs. If errors are detected, then automated remediation operations may be performed, such as modifying network interface settings or forcing a reboot of a network device, and the scanning of the network interfaces may be repeated to ensure the errors are fixed.

In an embodiment, the network devices may also include computers connected to the network infrastructure. For example, servers or other types of computers connected to a network may have configuration settings that can be analyzed by the network configuration management system to detect configuration setting errors, which may cause security vulnerabilities. Configuration settings may be retrieved from the computer and may be stored in a text file. SNMP commands may be used to retrieve configuration settings for Unix computers. For computers running other types of operating systems, a program may be used to remotely access the computer to retrieve configuration settings. For example, Windows PowerShell® remote commands may be used for computers running Windows®. Also, network interfaces of the computer may be scanned to test for open ports and other security vulnerabilities.

Network configuration setting errors can be caused by user errors and may also be caused by unauthorized users trying to maliciously gain access to network devices and computers connected to a network. There are often instances when network administrators manually change configuration settings of network devices, and mistakes can easily happen when manually changing the configuration settings. These mistakes may cause security vulnerabilities. For example, a network administrator may misconfigure an ACL list or misconfigure ports, which can result in a network device failing to block network traffic that is supposed to be blocked. The network configuration management system can detect these types of failures and errors and remediate the errors through automated configuration setting error detection and remediation to minimize security vulnerabilities and prevent malicious network attacks. Also, another problem that is known to happen in network devices is that an ACL fails due to a software bug in an operating system of the network device, resulting in network traffic being routed when it should be blocked. This type of ACL failure can be difficult to detect because the ACL may be correctly configured even though the network device is not filtering network traffic according to the ACL. The network configuration management system can detect these types of failures through network interface scanning and analysis of the scanning results.

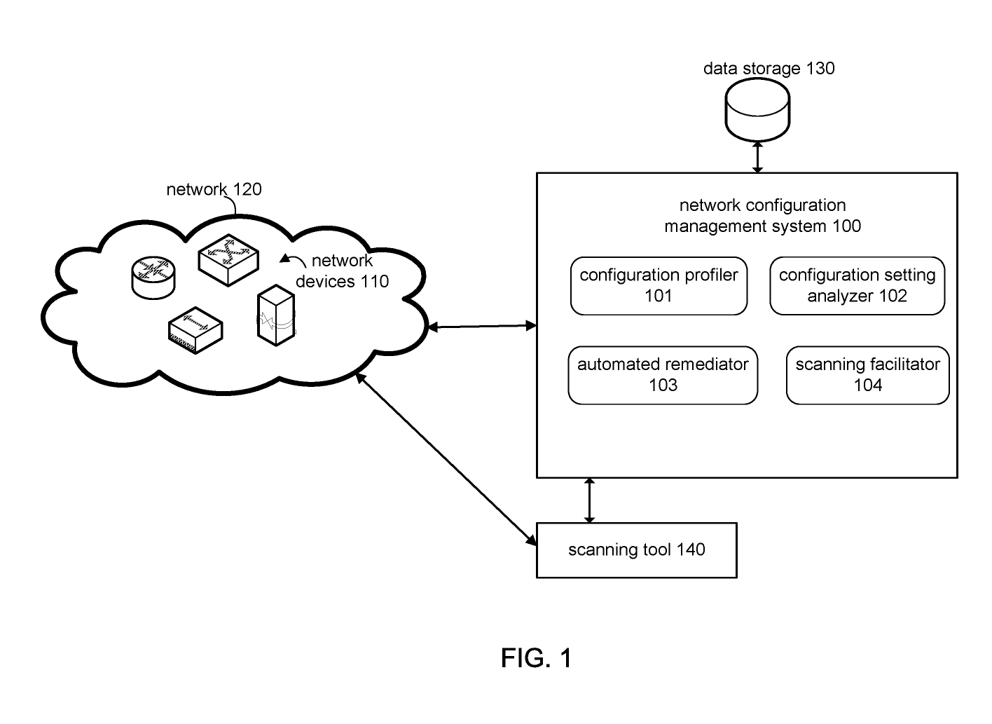

FIG. 1 illustrates a network configuration management system 100, according to an embodiment, that can manage configuration settings of network devices 110 in one or more networks, such as the network 120. The network devices 110 may include routers, switches, hubs, bridges, firewalls, load balancers, gateways, etc. The network 120 may include the network devices 110 and one or more data links that enable the transport of electronic data between computer systems and/or modules and/or other electronic devices. The data links may include wired, wireless, or a combination of wired and wireless. The network 120 may comprise one or more of the Internet, an intranet, a Local Area Network (LAN), a wireless LAN (WiLAN), a Wide Area Network (WAN), a Metropolitan Area Network (MAN), a Public Switched Telephone Network (PSTN), a Wireless Personal Area Network (WPAN) and other types of wired and/or wireless communications networks. The network 120 may be a network in a cloud computing environment. The cloud computing environment may be distributed, although not required, and may even be distributed internationally and/or have components possessed across multiple organizations. The cloud computing environment may include a shared pool of configurable computing resources (e.g., networks, servers, storage, applications, and services) that are provisioned in the network 120 as needed.

The network configuration management system 100 may include a configuration profiler 101, a configuration setting analyzer 102, automated remediator 103, and scanning facilitator 104. The configuration profiler 101 may determine configuration settings for the network devices 110. In an example, the configuration profiler 101 may include scripts to retrieve the configuration settings from the network devices 110 using network addresses provided for the network devices 110. For example, scripts may execute known protocol commands, such as Telnet commands, simple network management protocol (SNMP) commands or secure shell (SSH) commands, to retrieve configuration settings of network devices 110. The configuration settings may be stored in configuration files in the network devices 110, and the configuration files may be retrieved from the network devices 110. In another embodiment, the configuration profiler 101 may instruct scanning tool 140 to retrieve the current configuration files from the network devices 110. The retrieved configuration settings, which may be provided in configuration files, may be stored in data storage 130. In another embodiment, the network devices 110 may be configured by pushing configuration files to the network devices 110 to configure their configuration settings according to the configuration files. The configuration files sent to the network devices 110 may be stored in the data storage 130, and the configuration profiler 101 can retrieve the configuration files sent to the network devices 110 from the data storage 130 to determine the configuration settings of the network devices 110. However, if one or more of the configuration settings of a network device is modified after pushing configuration settings to the network device, such as by a network administrator remotely logging into the network device to change a configuration setting, the current configuration settings of the network device can be determined by retrieving the current configuration settings from the network device.

The configuration setting analyzer 102 may detect configuration setting errors in the configuration settings of the network devices 110 determined by the configuration profiler 101. The configuration setting errors may include configuration setting value errors and supplemental access setting errors. A configuration setting value error may be an incorrect configuration setting value, such as an incorrect IP address of a syslog server, or an incorrect IP address in an ACL. A supplemental access setting error may include extra data in the configuration settings of a network device that may cause security vulnerability by allowing access to the network device, such as an unapproved administrator login or other setting that allows unapproved remote access to a network device. The supplemental access setting error may include information that allows access to information in a network device, such as a user login and password or other information that is used by a network device to authenticate a user. Examples of configuration setting errors are further discussed below. Also, configuration setting errors may be detected by comparing configuration settings of a network device to configuration settings that are predetermined to be correct.

The automated remediator 103 can execute remediation operations in response to detecting configuration setting errors. The remediation operations may include generating and sending notifications of detected configuration setting errors to system administrators, uploading corrected configuration settings to network devices to fix the configuration setting errors, and other operations further discussed below.

The scanning facilitator 104 facilitates scanning the network devices 110, for example, via scanning tool 140. The scanning facilitator 104 may determine the network addresses, such as IP addresses, Media Access Control (MAC) addresses, etc., of network interfaces of the network devices 110 from configuration settings of the network devices. The network interfaces may include ports on routers, switches, gateways, etc. The scanning facilitator 104 may provide the network addresses to the scanning tool 140 to execute a scan of the network interfaces to test ACLs of the network interfaces. For example, the scanning tool 140 may send packets to the network interfaces to determine whether the network interfaces are blocking traffic that is supposed to be blocked and to determine whether network interfaces are routing traffic that is supposed to be routed. Also, the scanning tool 140 may determine through port scanning whether any of the network interfaces are configured as open ports that can make a network device vulnerable to attack. An open port is a port, such as a Transmission Control Protocol (TCP) port or a User Datagram Protocol (UDP) port that accepts packets. In contrast, a port which blocks all packets directed to it is a closed port. An open port can cause security vulnerability, because a service or program listening for incoming packets on an open port may be exploited. The scanning tool 140 may execute a scan from a computer that is connected to the network devices 110 via the Internet and that has no special privileges to test whether the network devices 110 are vulnerable to network attacks via the Internet. Also, the scanning tool 140 may execute a scan from a computer that has an internal IP address, such as from a host having an IP address in the same subnet or intranet of the network devices 110, to test whether the network devices 110 may be vulnerable to internal attacks.

The scanning tool 140 may include an off the shelf (OTS) scanning tool, such as Nmap (Network Mapper) which is an open source utility for network discovery and security auditing or another available scanning tool. In an embodiment, the scanning tool 140 may be hosted on one or more computers separate from the network configuration management system 100. The scanning tool 140 may be hosted on a computer outside the network being scanned to test for security vulnerabilities and attacks that may originate outside the network. Although not shown, the network configuration management system 100 may be connected to the scanning tool 140 via a network, such as the network 120. The network configuration management system 100 may send instructions, which include the network addresses of network interfaces of the network devices 110, to the scanning tool 140, to instruct the scanning tool 140 to scan the network interfaces. The scanning tool 140 executes the scan and sends the results of the scan to the network configuration management system 100. The network configuration management system 100 may execute remedial operations to close ports that are open but are supposed to be closed or to correct ACL failures. In another embodiment, the scanning tool 140 may be part of the network configuration management system 100.

The data storage 130 may include a storage system to store information used by the system 100. The data storage 130 may include a file system, a database or another type of storage system. Examples of the information stored in the data storage 130 may include configuration settings of the network devices 110 which may be provided in configuration files, configuration setting templates that include predetermined, correct configuration settings for different types of network devices, network addresses of network interfaces, or other information used by the network configuration management system 100.

According to an embodiment, the configuration profiler 101, the configuration setting analyzer 102, the automated remediator 103, and the scanning facilitator may be comprised of machine readable instructions stored on one or more non-transitory computer readable medium and executable by one or more processors. A platform including hardware components for the network configuration management system 100 is further described below.

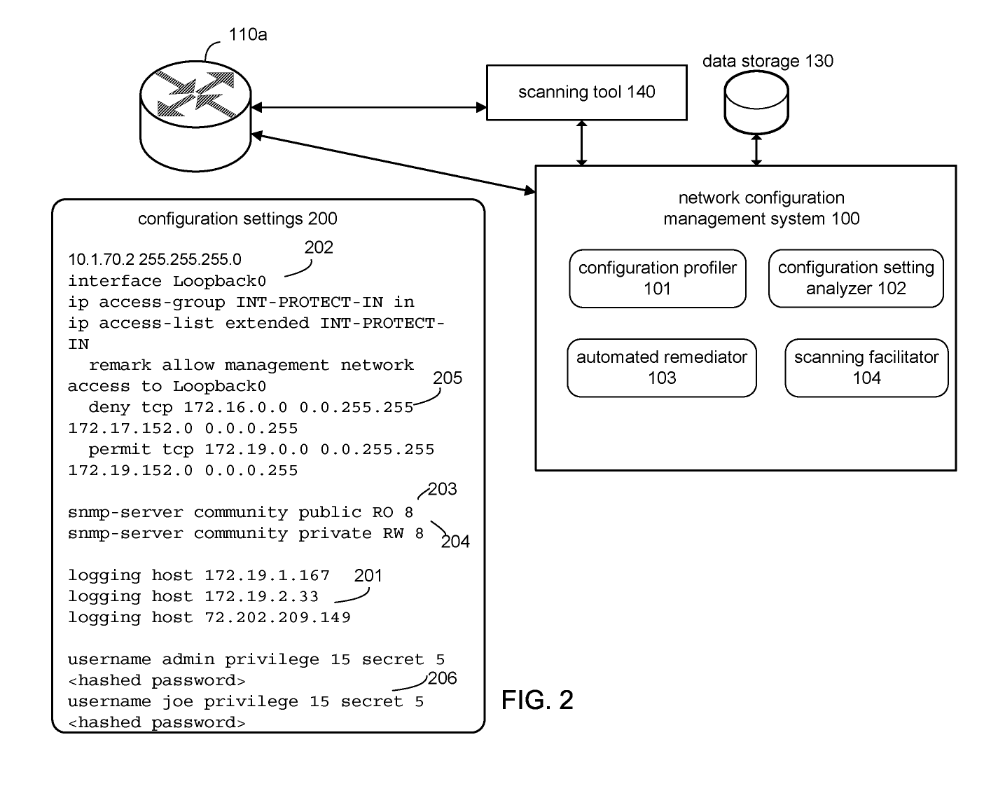

FIG. 2 shows an example of the network configuration management system 100 managing configuration settings 200 for network device 110a of the network devices 110. In this example, the network device 110a is a router but the network configuration management system 100 may manage configuration settings for other types of network devices. The configuration settings 200 are examples of some configuration settings for the network device 110a but it will be apparent to one of ordinary skill in the art that the network device 110a may include configuration settings other than what are shown.

The configuration settings 200 may include a log setting for capturing and storing events occurring at the network device 110a. Syslog setting 201 is an example of a log setting that specifies one or more destinations, e.g., one or more syslog servers, for receiving logs of the captured events. For example, 172.19.1.167, 172.19.2.33 and 72.202.209.149 are IP addresses of syslog servers specified in the syslog setting 201. The network device 110a captures events and sends a log of the events to the IP addresses specified in the syslog setting 201. The syslog setting 201 may also include other settings not shown, such as a setting to timestamp syslog messages and may include other settings related to syslog parameters.

Another example of the configuration settings 200 is interface settings 202 that include parameters for network interfaces of the network device 110a. The network device 110a may have multiple network interfaces or ports. Interface settings for a single network interface are shown but the configuration settings 200 may include multiple interface settings for each of multiple network interfaces of the network device 110a. Also, the interface settings 202 may include interface settings other than what are shown. The interface settings 202 shown in this example include the type of network interface, e.g., Loopback0, and its IP address, e.g., 10.1.70.2 255.255.255.0.

The interface settings 202 may also include Simple Network Management Protocol (SNMP) community string settings 203 and 204. A community string is a password that allows access to a network device. It defines what “community” of people can access the SNMP information on the network device. The system administrator may be responsible for setting the community strings on network devices, but if a community string is left at a known default value, it may be security vulnerability, as is further discussed below.

Examples of SNMP community strings include an SNMP Read-Only (RO) community string and an SNMP Read-Write (RW) community string. The SNMP RO community string may be sent with an SNMP Get-Request and allows (or denies) access to a router's or other network device's SNMP information, which may include variables in a management information base on the network device. If the community string is correct, the network device responds with the requested information. The SNMP RW community string is used in requests for information from a network device and to modify configuration settings on that network device. Community string setting 203 shows that the RO community string is set to the default or well known string “public”, and community string setting 204 shows that the RW community string is set to the default or well known string “private”.

The interface settings 202 may include ACL settings 205. The network device 110a may use ACLs to control inbound and outbound traffic on network interfaces. For example, the ACL settings 205 specify “INT-PROTECT-IN” as the ACL for inbound traffic for this network interface and no ACL is set for outbound traffic for this network interface. The filtering rules in the ACL settings 205 are as follows, denying traffic from the 172.16.0.0 network and permitting traffic from the 172.19.0.0 network with an implicit “deny everything else” at the end:

deny tcp 172.16.0.0 0.0.255.255 172.17.152.0 0.0.0.255 permit tcp 172.19.0.0 0.0.255.255 172.19.152.0 0.0.0.255.

Yet another example of the configuration settings 200 are administrator login credential settings 206. The administrator login credential settings 206 may include login IDs and passwords for administrators, and an administrator may log into the network device 110a with one of the login IDs and its corresponding password to view and modify configuration settings. The administrator login credentials stings 206 include:

username admin privilege 15 secret 5<hashed password>

username joe privilege 15 secret 5<hashed password>.

The username admin may be an authorized administrator login credential, and the username joe may be an administrator login credential that is identified as unauthorized by the network configuration management system 100 as is further described below.

As discussed with respect to FIG. 1, the configuration profiler 101 of the network configuration management system 100 may determine the configuration settings of the network devices 110. For example, the configuration settings 200 of the network device 110a may be determined by retrieving them from the network device 110a or from the data storage 130 if the configuration settings 200 stored in the data storage 130 are current. The configuration setting analyzer 102 may determine if the configuration settings 200 include configuration setting errors.

The configuration setting errors may include a configuration setting value error or a supplemental access setting error. A configuration setting value error may include a configuration setting that is set to an incorrect or improper value, which may be determined by comparing a configuration setting of a network device to a predetermined value for that configuration setting. A supplemental access setting error may include extra data in the configuration settings of a network device that may cause security vulnerability by allowing access to the network device.

According to an embodiment, the configuration setting analyzer 102 may compare the configuration settings 200 to predetermined values. The predetermined values may be stored in the data storage 130. For example, approved configuration setting values may be stored in the data storage 130 for syslog servers, approved administrator credentials, etc., and the configuration setting analyzer 102 compares the configuration settings determined for the network device 110a to the approved configuration setting values may be stored in the data storage 130 to detect configuration setting errors.

If the approved configuration setting values are different for different types of network devices, the data storage 130 may store templates of predetermined, approved configuration setting values for different types of network devices. For example, the configuration setting analyzer 102 may determine information for the network device 110a, such as the type of the network device (e.g., router, firewall, gateway, etc.), the manufacturer, model number, IP address, etc. Based on this information, the configuration setting analyzer 102 may identify a template of predetermined configuration setting values for the network device 110a that is stored in the data storage 130 for comparison to the determined for the network device 110a. The data storage 130 may store a plurality of templates for different types, manufacturers, etc. of network devices.

The automated remediator 103 may execute remedial actions if a configuration setting error is detected by the configuration setting analyzer 102. Different remedial actions may be executed depending on the type of configuration setting error. The configuration setting analyzer 102 may identify correct configuration settings values for configuration setting value errors, and send the correct values to the automated remediator 103. The automated remediator 103 may access the network device 110a, such as through telnet, SSH, SNMP, etc., to modify the incorrect configuration settings of the network device to a correct value. If the configuration setting analyzer 102 identifies a supplemental access setting error in the network device 110a, the automated remediator 103 may access the network device 110a to delete the supplemental access setting error. Also, alerts may be generated for configuration setting errors determined to be malicious or security vulnerabilities. The alerts may include messages sent to network administrators or other users. The alerts may include emails, text messages, etc., and provide information about the detected configuration setting error and the particular network device having the error. In an example, a remedial action may be executed that includes generating a report of any determined configuration setting errors. The report may be transmitted to predetermined users. The report may categorize configuration setting errors by security vulnerability threat levels, such as low, medium, or high, based on predetermined criteria.

Examples of determining configuration setting errors and auto-remediating the configuration setting errors are now described. The syslog setting 201 specifies a destination, i.e., a syslog server, for logging the captured events. The configuration setting value for the syslog setting 201 is 72.202.209.149. To detect a configuration setting error for the syslog setting, the configuration setting analyzer 102 may determine whether the syslog server is set, and, if the syslog server is set, the configuration setting analyzer 102 may determine whether the IP address of the syslog server is correct. This may include determining whether the IP address of the syslog server is equivalent to a predetermined (e.g., pre-approved) IP address. The configuration setting analyzer 102 may compare the IP address of the syslog server to a range of predetermined IP addresses that are pre-approved. If the IP address of the syslog server is not in the range than it is considered a configuration setting error. The configuration setting analyzer 102 may determine whether the IP address of the syslog server is an internal IP address, such as an Intranet IP address, or an Internet IP address. If the syslog server is set to an unknown Internet IP address, a hacker may be receiving the logs of the network device 110a and may be able to use information in the logs to gain unauthorized access to the network or to execute network attacks. If the IP address of the syslog server is determined to be an Internet IP address instead of an internal IP address, it may be considered a configuration setting error. For example, an Intranet IP address may be in the range of 10.0.0.00 through 10.255.255.255, and 172.16.0.0 through 172.31.255.255, and 192.168.0.0 through 192.168.255.255. An Internet IP address may range from 1 to 191 in the first octet. These ranges may be used to identify a syslog server set to an Internet IP address.

In this example, the syslog server setting 201 is 72.202.209.149. The configuration setting analyzer 102 may determine that this is a public IP address, and notify the automated remediator 103. The automated remediator 103 may determine the proper IP address, for example, from a predetermined syslog server IP address stored in the data storage 130, and update the syslog server IP address on the network device 110a.

Another example of a configuration setting value error is associated with SNMP community strings. Many network device vendors ship their equipment with default values of “public” and “private” for SNMP community strings. Many network administrators change the SNMP community strings to keep intruders from getting information about the network setup. Community string settings 203 and 204 are “public” and “private”, respectively, which may both be considered configuration setting value errors. These default SNMP community string settings may be considered security vulnerability because the default settings are well known. Accordingly, a malicious user may use the “public” SNMP community string to retrieve information about the network device 110a, such as the device operating system (OS), and may use known vulnerabilities of the OS to execute a network attack. Also, a malicious user may modify SNMP settings using the “private” SNMP community string to make the network device 110a more vulnerable to a network attack. The automated remediator 103 may execute one or more remedial operations, such as disabling the SNMP service on the network device 110a, setting filters on incoming UDP packets going to a network interface or port receiving SNMP requests, or modifying the default SNMP community strings to predetermined non-default values.

To detect a supplemental access setting error which may be a security vulnerability, the administrator login credential settings 206 may be compared to a whitelist of approved administrator logins stored in the data storage 130. If an unapproved administrator login is identified it is considered a supplemental access setting error, and may be remediated. For example, the login “Joe” in the administrator login credential settings 206 is determined not to be on the whitelist. The automated remediator 103 accesses the network device 110a to delete “Joe” from the administrator login credential settings 206.

Another example of a configuration setting error may include an incorrect ACL assigned to a network interface or incorrect filters in an ACL. The ACLs may be modified as needed. Another example of a configuration setting that may cause security vulnerability is a root login. A root login, such as an SSH root login, may allow the user full access to files and configuration settings on a network device. The automated remediator 103 may disable root user logins.

The scanning facilitator 104 can initiate a scan of network interfaces of the network device 110. For example, the scanning facilitator 104 identifies IP addresses of the network interfaces from the configuration settings of the network devices 110, such as IP address 10.1.70.2 255.255.255.0 in the interface setting 202. The scanning facilitator 104 extracts the IP addresses of the network devices 110 and sends an instruction or command, along with the IP addresses, to the scanning tool 140 to scan the IP addresses. The scanning tool 140 scans the IP addresses for network interface errors, such as to check for open ports or ACL failures, and sends a report of the network interface errors to the network configuration management system 100. The network configuration management system 100 may attempt to remediate the errors through reconfiguration of ACLs or other configuration settings. The network configuration management system 100 may send notifications of the network interface errors to a network administrator. After implementing fixes for the network interface errors, the scanning tool 140 may be instructed to re-scan the network interfaces to determine if the network interface errors are fixed.

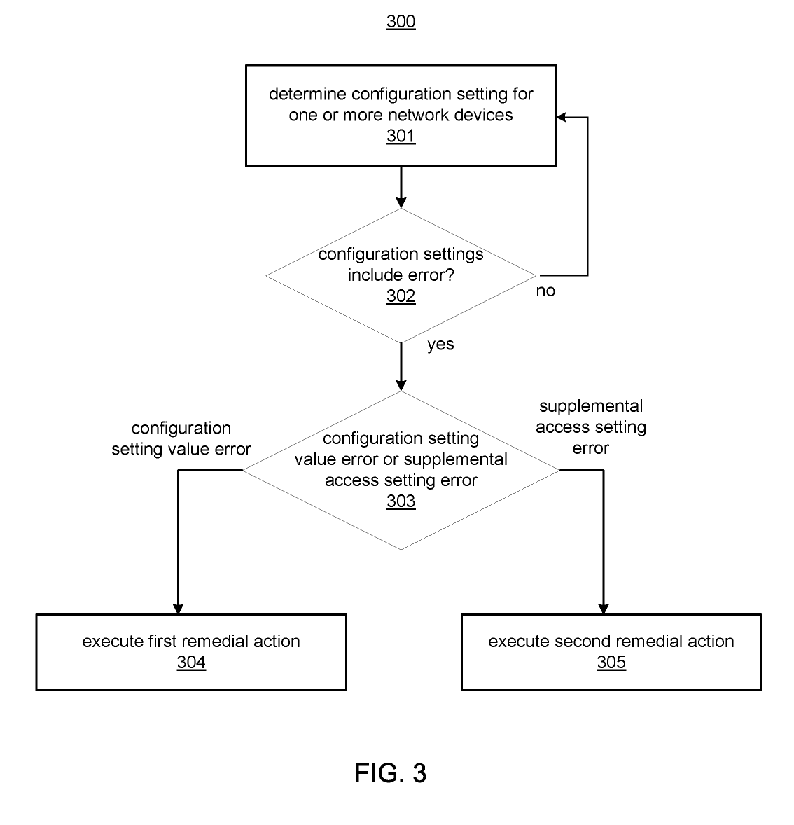

FIG. 3 illustrates a method 300, according to an embodiment, for determining configuration setting errors. The method 300 and other methods described herein are described by way of example as being performed by the network configuration management system 100. At 301, the configuration profiler 101 determines configuration settings for one or more of the network devices 110. For example, configuration files are retrieved from the network devices 110 and stored in the data storage 130. The configuration files may be parsed to determine the configuration settings of the network devices 110.

At 302, the configuration setting analyzer 102 determines whether the configuration settings determined at 301 include a configuration setting error comprising a configuration setting value error or a supplemental access setting error. For example, configuration settings of the network devices not matching predetermined values may be considered configuration setting value errors, and supplemental data, such as unapproved administrator logins or passwords that allow access to a network device, may be considered a supplemental access setting error that is a configuration setting error.

At 302, if a configuration setting determined at 301 is not determined to be a configuration setting error, then 301 may be repeated for another determined configuration setting. At 302, if a configuration setting determined at 301 is determined to be a configuration setting error, at 303, a determination is made as to whether the configuration setting error is a configuration setting value error or a supplemental access setting error.

If the configuration setting error is a configuration setting value error, a first remedial action may be executed at 304, and if the configuration setting error is a supplemental access setting error, a second remedial action may be executed at 305. The remedial actions may be executed by the automated remediator 103. The remedial actions may be different. Examples of the remedial actions are discussed above.

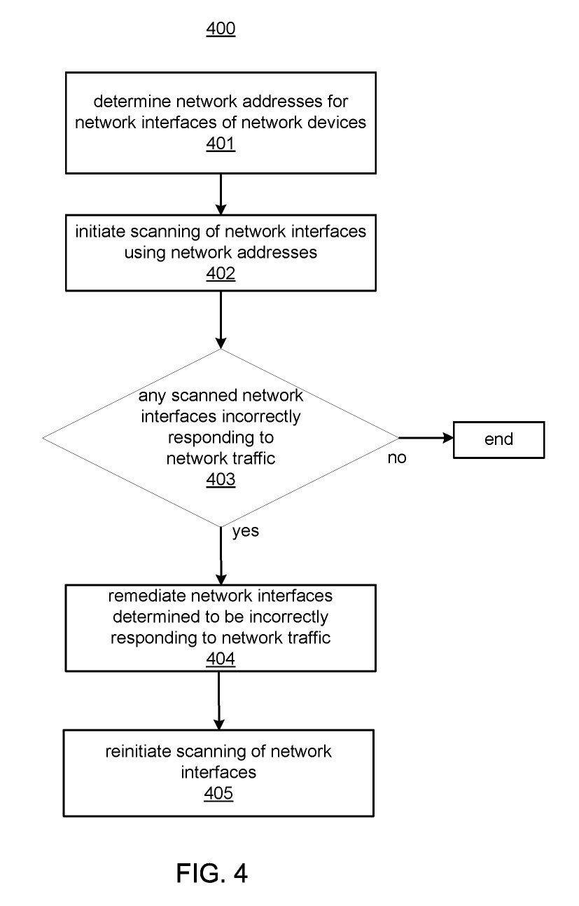

FIG. 4 illustrates a method 400, according to an embodiment, for executing a network interface scan based on information from configuration settings. At 401, network addresses are determined for network interfaces of the network devices 110 from the configuration settings for the network devices. For example, configuration files for the network devices 110 are parsed to identify the IP addresses of network interfaces from the interface settings of the network devices 110. At 402, the scanning facilitator initiates scanning of the network interfaces using the network addresses. For example, the scanning facilitator 104 sends an instruction or command, along with the network addresses of the network interfaces, to the scanning tool 140 to scan the network interfaces.

At 403, based on the scanning, the configuration setting analyzer 102 determines whether any of the scanned network interfaces is incorrectly responding to network traffic. Network interfaces incorrectly responding to network traffic may include misconfigured ports, or ACL failures. An ACL failure may include a network interface failing to filter network traffic that is supposed to be filtered according to a rule specified in the ACL. This may be due to a software bug in the network device causing it to malfunction. An ACL failure may also include a misconfigured ACL. For example, the ACL may not include a rule to block traffic from a particular host that is supposed to be blocked, and thus the rule needs to be added to the ACL.

Based on the scanning results, the configuration setting analyzer 102 may determine whether ports are misconfigured. A misconfigured port may include a port that is supposed to be one of open, closed or blocked, but is not. For example, a misconfigured port may be a port that is open, contrary to a security policy. For example, if a port is configured for Character Generator Protocol (CHARGEN), Network Time Protocol (NTP), Domain Name System (DNS), or Internet Control Message Protocol (ICMP), and is an open port, it may be considered security vulnerability for its susceptibility to reflection network attacks. Also, SSH and Telnet ports that are open may be considered a network configuration setting error. These types of configured ports may be considered network configuration setting errors, and the ports may be closed to reduce security vulnerabilities.

According to an embodiment, to analyze the scanning results from the scanning tool 140, the configuration setting analyzer 102 may receive a textual report from the scanning tool 140 that identifies the IP addresses and scanning results for each IP address. The scanning results may include information for each scanned network interface, such as by IP address. For example, the scanning results may identify whether a network interface (e.g., a port) is open, closed, or filtered. The port may be considered open if the network device sent a reply indicating that a service is listening on the port. The port may be considered closed if the network device sent a reply indicating that connections to the port are denied. The port may be considered filtered if the network device did not reply. The configuration setting analyzer 102 may compare the scanning results for each port to predetermined configuration settings for each port, such as whether the port should be open, closed or filtered, to determine whether any of the ports are misconfigured, which may cause the ports to incorrectly respond to network traffic.

At 404, the network interfaces determined to be incorrectly responding to network traffic may be remediated, such as by reconfiguring an open port to be a closed port, or by reconfiguring a closed port to be an open port, or by reconfiguring an ACL, or by correcting an ACL that may not be operational due to a software bug through a software update and/or a reboot. The remedial actions may be executed by the automated remediator 103.

At 405, the scanning facilitator 104 may reinitiate scanning of the network interfaces to verify that the remediated network interfaces are responding to network traffic correctly. For example, after a network interface is reconfigured, such as by adjusting port settings or an ACL, the scanning is re-initiated for the network interface. If the remedial actions did not correct the incorrectly operating network interfaces, then additional remedial actions may be performed and/or alerts may be generated to escalate improperly operating network devices to a higher fault status to help ensure the improperly operating network devices are corrected in a timely manner.

According to an embodiment, the configuration setting analyzer 102 may determine whether a configuration setting error determined is an intentional or an unintentional configuration setting error. In an embodiment, the determination may be performed at step 302 of the method 300 and/or at step 403 of the method the method 400. An intentional configuration setting error may be considered higher security vulnerability than an unintentional configuration setting error, and different or additional remedial actions may be performed for an intentional configuration setting error, such as generating alerts with a “high” importance notification, shutting down a network device or disabling a port, etc. An unintentional configuration setting error may be reconfigured without disabling a port or isolating and shutting down a network device and may not cause an alert to be generated unless it cannot be auto-remediated.

According to an embodiment, categories of configuration setting errors are stored, such as intentional and unintentional categories. The configuration setting analyzer 102 may determine whether a configuration setting error, such as determined at 302 or determined from the scanning at 402, falls under one of the categories to determine the remedial actions to execute. Examples of intentional and unintentional configuration setting errors are now described. Unapproved administrator credentials stored on a network device that allow reading or modifying a configuration setting may be categorized as intentional. The administrator credentials, for example, extracted from a configuration file of a network device may be compared to a “white” list of approved administrator credentials. If the extracted administrator credentials are not on the approved “white” list and are not merely a typo or misspelling, which may be determined by a regular expression operation (regex), then the extracted administrator credentials may be categorized as an intentional configuration setting error. In another example, a “black” list of unauthorized administrator credentials is stored, which may include administrator credentials known to be used by hackers. If the extracted administrator credentials match administrator credentials on the “black” list, then it may be categorized as intentional. In another example, if a syslog server setting is on a “black” list of unauthorized IP addresses which may be known to be used by hackers, then it may be categorized as intentional. In yet another example, if a syslog server setting is set to a public IP address, then it may be categorized as intentional. In yet another example, an SNMP community string set to a known default setting, such as “public” or “private” may be categorized as unintentional.

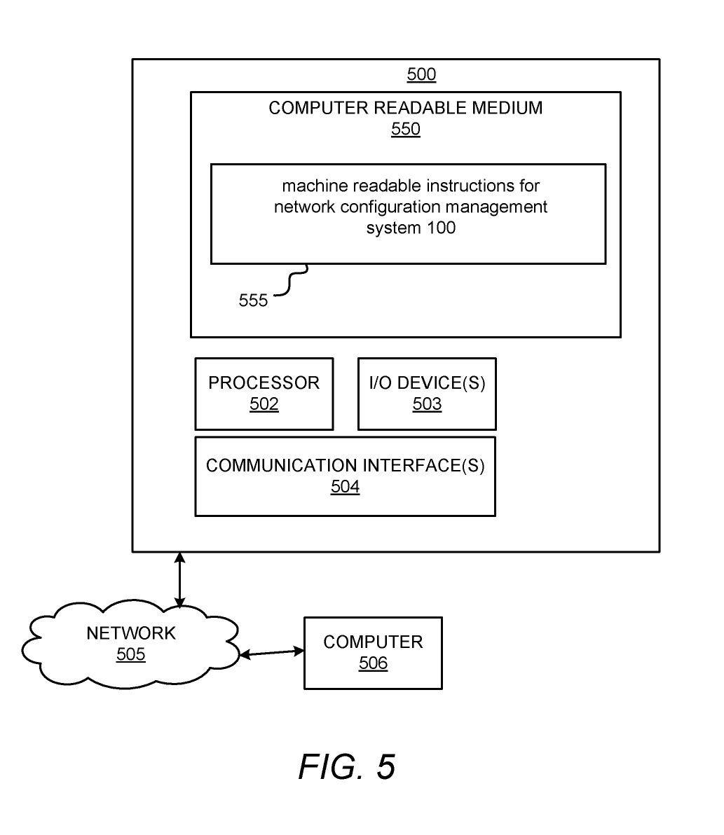

FIG. 5 shows a computer 500 that may be used as a platform for the network configuration management system 100, according to an embodiment. The computer 501 may include a processor 502 and a computer readable medium 550 on which is stored machine readable instructions 555 that the processor 502 may fetch and execute. The processor 502 may be a semiconductor-based microprocessor, a central processing unit (CPU), an application specific integrated circuit (ASIC), a field-programmable gate array (FPGA), and/or other hardware device. The computer readable medium 550 may be a non-transitory computer readable medium comprised of an electronic, magnetic, optical, or other type of physical storage that stores the machine readable instructions 555. The computer readable medium 550 may be, for example, Random Access Memory (RAM), an Electrically Erasable Programmable Read-Only Memory (EEPROM), a storage device, an optical disc, and the like. The computer readable medium 550 may be a non-transitory machine-readable storage medium, where the term “non-transitory” does not encompass transitory propagating signals. The processor 502 may include one or more processors. The computer 501 may include one or more input/output (I/O) devices 503, such as a keyboard, mouse, pen, voice input device, touch input device or a display.

The computer 500 may include communication interface(s) 504 that allows the computer 500 to communicate with other computers, such as computer 506. For example, if the scanning tool 140 is hosted on the computer 506, and the network configuration management system 100 may communicate with the scanning tool 140 via the communication interface(s) 504. The communication interface(s) 504 may include, but is not limited to, a modem, a Network Interface Card (NIC), an integrated network interface, a radio frequency transmitter/receiver, an infrared port, a USB connection, or other interfaces. The communication interface(s) 104 may connect with other computers via a wired connection or a wireless connection. The communication interface(s) 504 may include a network interface to connect with other computers, including the computer 506, via network 505. The network 505 may comprise one or more of the Internet, an intranet, a Local Area Network (LAN), a wireless LAN (WiLAN), a Wide Area Network (WAN), a Metropolitan Area Network (MAN), a Public Switched Telephone Network (PSTN), a Wireless Personal Area Network (WPAN) and other types of wired and/or wireless communications networks. The network 505 may be a network in a cloud computing environment.

The processor 502 may fetch and execute the machine readable instructions 555 to perform operations of the network configuration management system 100. The operations include operations described herein for the configuration profiler 101, the configuration setting analyzer 102, the automated remediator 103, and the scanning facilitator 104.

Embodiments and examples are described above, and those skilled in the art will be able to make various modifications to the described embodiments and examples without departing from the scope of the embodiments and examples.

What is claimed is:

1. A network configuration management system comprising:
at least one processor; and
at least one data storage storing machine readable instructions executable by the at least one processor to:
determine configuration settings for at least one network device;
determine whether the configuration settings include a configuration setting error comprising a configuration setting value error or a supplemental access setting error;
if the configuration settings include the configuration setting value error, execute a first remedial action; and
if the configuration settings include the supplemental access setting error, execute a second remedial action.

2. The network configuration management system of claim 1, wherein the at least one processor is to:
determine network addresses for network interfaces of the at least one network device from the configuration settings for the at least one network device;
initiate scanning of the network interfaces using the network addresses to determine whether a scanned network interface is incorrectly responding to network traffic.

3. The network configuration management system of claim 2, wherein the at least one processor is to:
determine, from the scanning, that at least one of the scanned network interfaces is incorrectly responding to network traffic; and
reinitiate scanning of the at least one network interface after the at least one network interface is reconfigured to correct the incorrect responding to network traffic.

4. The network configuration management system of claim 3, wherein to determine that at least one of the scanned network interfaces is incorrectly responding to network traffic, the at least one processor is to:
determine whether the at least one scanned network interface has an access control list failure, wherein the access control list failure comprises at least one of:
failing to filter network traffic that is supposed to be filtered according to a rule specified in the access control list for the scanned network interface; and
failing to filter network traffic that is supposed to be filtered due to the access control list failing to include a rule to filter the network traffic.

5. The network configuration management system of claim 3, wherein to determine that at least one of the scanned network interfaces is incorrectly responding to network traffic, the at least one processor is to:
determine the at least one scanned network interface is configured as an open port.

6. The network configuration management system of claim 1, wherein to determine whether the configuration settings include a configuration setting value error, the at least one processor is to:
determine whether the configuration settings include at least one of: a simple network management protocol community string set to a default value, a log destination configuration setting set to an unapproved destination, and a configuration setting allowing a user to login as a root user.

7. The network configuration management system of claim 1, wherein to determine whether the configuration settings include a supplemental access setting error, the at least one processor is to:
determine whether unapproved user credentials are configured on the at least one network device that allow access to configuration settings of the at least one network device.

8. The network configuration management system of claim 1, wherein to execute a first remedial action if the configuration settings include the configuration setting value error, the at least one processor is to:
identify a configuration setting of the at least one network device that is determined to have an incorrect configuration setting value; and
modify the configuration setting in the at least one network device to have a corrected configuration setting value.

9. The network configuration management system of claim 1, wherein to execute a second remedial action if the configuration settings include the supplemental access setting error, the at least one processor is to:
delete the supplemental access setting error from the at least one network device.

10. At least one non-transitory computer readable medium storing machine readable instructions executable by at least one processor to:
determine configuration settings for network devices;
determine whether the configuration settings include configuration setting errors comprising:
a simple network management protocol community string set to a default value, a log destination configuration setting set to an incorrect destination, and a configuration setting allowing a user to login as a root user; and
when the configuration settings include at least one of the configuration setting errors, execute a remedial action.

11. The at least one non-transitory computer readable medium of claim 10, wherein to determine whether the configuration settings include at least one of the configuration setting errors, the at least one processor is to determine whether the configuration settings include a configuration setting error comprising a supplemental access setting error.

12. The at least one non-transitory computer readable medium of claim 11, wherein the supplemental access setting error comprises unapproved user administrator credentials that allow a user to log into at least one of the network devices and modify or read the configuration settings of the at least one network device.

13. The at least one non-transitory computer readable medium of claim 10, wherein the at least one processor is to:
determine network addresses for ports of the network devices from the configuration settings; and
initiate scanning of the ports using the network addresses to determine whether a scanned port is incorrectly responding to network traffic.

14. The at least one non-transitory computer readable medium of claim 13, wherein the at least one processor is to:
determine, from the scanning, that at least one of the scanned ports is incorrectly responding to network traffic; and
reinitiate scanning of the at least one port after reconfiguring the port.

15. The at least one non-transitory computer readable medium of claim 14, wherein to determine that at least one of the scanned ports is incorrectly responding to network traffic, the at least one processor is to:
determine whether the at least one scanned port has an access control list failure, wherein the access control list failure comprises at least one of:
failing to filter network traffic that is supposed to be filtered according to a rule specified in the access control list for the scanned port; and
failing to filter network traffic that is supposed to be filtered due to the access control list failing to include a rule to filter the network traffic.

16. The at least one non-transitory computer readable medium of claim 14, wherein to determine that at least one of the scanned ports is incorrectly responding to network traffic, the at least one processor is to:
determine the at least one scanned port is configured as an open port.

17. A computer-implemented method comprising:
determining configuration settings for at least one network device;
determining the configuration settings include a configuration setting error;
determining whether the configuration setting error comprises an intentional configuration setting error or an unintentional configuration setting error;
in response to determining the configuration setting error comprises the intentional configuration setting error, executing a first remedial action; and
in response to determining the configuration setting error comprises the unintentional configuration setting error, executing a second remedial action.

18. The computer-implemented method of claim 17, wherein the intentional configuration setting error comprises at least one of:
unapproved administrator credentials configured on the at least one network device that allow access to configuration settings of the at least one network device, wherein the unapproved user credentials are determined not to match pre-approved administrator credentials or determined to match a pre-determined unapproved administrator credential; and
a syslog server configuration setting set to a public network address or to a pre-determined unapproved network address.

19. The computer-implemented method of claim 17, wherein the unintentional configuration setting error comprises a simple network management protocol community string set to a default value.

20. The computer-implemented method of claim 17, comprising:
determining network addresses for interfaces of the at least one network device from the configuration settings for the at least one network device; and
initiating scanning of the network interfaces using the network addresses to determine whether a scanned network interface is incorrectly responding to network traffic.
